(19) United States
(12) Patent Application Publication
(10) Pub. No.: US 2003/0009564 A1
(43) Pub. Date: Jan. 9, 2003

(54) Methods and apparatus for an improved corporate portal

(76) Inventor: Randall W. Eckel, Phoenix, AZ (US)

Correspondence Address: Daniel R. Pote, Esq., SNELL & WILMER L.L.C., One Arizona Center, 400 East Van Buren, Phoenix, AZ, 85004-2202, US

(21) Appl. No.: 10/066,308

(22) Filed: Jan. 30, 2002

Related U.S. Application Data
(60) Provisional application No. 60/265,011, filed on Jan. 30, 2001.

(51) Int. Cl. G06F 15/16

(52) U.S. Cl. 709/227

(57) ABSTRACT

A corporate portal which, by incorporating pivot portal and knowledge explorer concepts, is configured to provide the user with relevant information gathered and filtered from disparate sources. A portal accessible by a plurality of users over a network comprises a portal page including a first pane and a second pane, the first pane including at least one knowledge map comprising a plurality of nodes selectable by the user, the second pane including at least one portal object responsive to the selection of nodes within the knowledge maps, wherein the portal object comprises information associated with the node selection. The nodes in the knowledge map may be displayed to the user in accordance with a taxonomy. The portal may also include a knowledge explorer configured to allow the user to select multiple nodes.

### CROSS-REFERENCE TO RELATED APPLICATIONS

This application claims priority from Provisional Patent Application No. 60/265,011, filed Jan. 30, 2001, which is hereby incorporated by reference.

### BACKGROUND OF THE INVENTION

1. Technical Field

The present invention relates, generally, to tools for accessing information over a network and, more particularly, to an improved corporate portal.

2. Background Information

The emergence of corporate and enterprise information portals has given businesses the tools necessary to help people aggregate, access, and navigate through data available from a variety of sources. Nevertheless, prior art corporate portals are unsatisfactory in a number of respects.

For example, traditional corporate portals typically include a great many pages defining the set of business functions that an enterprise and its users may wish to accomplish. The user must then navigate through the resulting maze of pages which, with varying degrees of success, have been pre-categorized into particular business functions—for example, searching, content management, applications, documents, discussions, and the like. One portal page will typically be created for collecting business information in one place, and may include such things as competitor websites, news feeds, and the like. Another page will commonly include unsorted and unfiltered information geared to a particular job. Other tools, such as Word and Excel might then used to create documents which are published using whatever content-management features the portal provides.

Analysis of available facts and data requires that the user navigate through an assortment of portal pages, participating in discussion groups, sending e-mails, participating in meetings, and using various standard software tools. A project leader or “community leader” may then create a collection of portal objects and add the people involved in the process into a group to create a new community. This page becomes part of the portal definition for each of the participants.

Decision-making using this paradigm is understandably inefficient. Studies have shown, for example, that approximately 30% of a knowledge worker's time is spent just looking for information and, at the same time, 60% of employees spend more than an hour each day duplicating the work done by others.

Methods are therefore needed in order to overcome these and other limitations of the prior art.

### BRIEF SUMMARY OF THE INVENTION

Systems and methods in accordance with the present invention overcome the prior art by providing a corporate portal which, by incorporating pivot portal and knowledge explorer concepts, is configured to provide the user with relevant information gathered and filtered from disparate sources.

In accordance with one embodiment of the present invention, a portal accessible by a plurality of users over a network comprises a portal page including a first pane and a second pane, the first pane including at least one knowledge map comprising a plurality of nodes selectable by the user, the second pane including at least one portal object responsive to the selection of nodes within the knowledge maps, wherein the portal object comprises information associated with the node selection.

In accordance with one aspect of the present invention, the nodes in the knowledge map are displayed to the user in accordance with a taxonomy.

In accordance with another aspect of the present invention, a knowledge explorer is configured to allow the user to select multiple nodes.

In accordance with another aspect of the present invention, the information associated with the selection of nodes comprises data gathered from at least one data source and filtered in accordance with the user's selection of nodes.

In accordance with another aspect of the present invention, a site menu is configured to allow the user to select a portal page from a plurality of pages arranged in a hierarchy.

In accordance with yet another aspect of the present invention, a list of favorites are provided for said user, wherein the list of favorites includes one or more of the nodes.

### BRIEF DESCRIPTION OF THE SEVERAL VIEWS OF THE DRAWINGS

The subject invention will hereinafter be described in conjunction with the appended drawing figures, wherein like numerals denote like elements, and:

FIG. 1 is a schematic overview of a portal page in accordance with the present invention;

FIG. 2 is an example portal page in accordance with various aspects of the present invention;

FIG. 3 is an example portal page showing the operation of a site menu;

FIG. 4 is an example portal page prior to selection of nodes;

FIG. 5 is an example portal page with portal objects reflecting the user's selection of nodes;

FIG. 6 is an example portal page configured as a decision workspace;

FIG. 7 is an example portal page as shown in FIG. 6 showing portal objects populated with relevant data;

FIG. 8 is an example portal page incorporating a “favorites” tab;

FIG. 9 is an example portal page illustrating the “join” feature;

FIG. 10 is an example portal page illustrating the “subscription” feature;

FIG. 11 shows an example knowledge explorer interface;

FIG. 12 shows an example knowledge explorer search result;

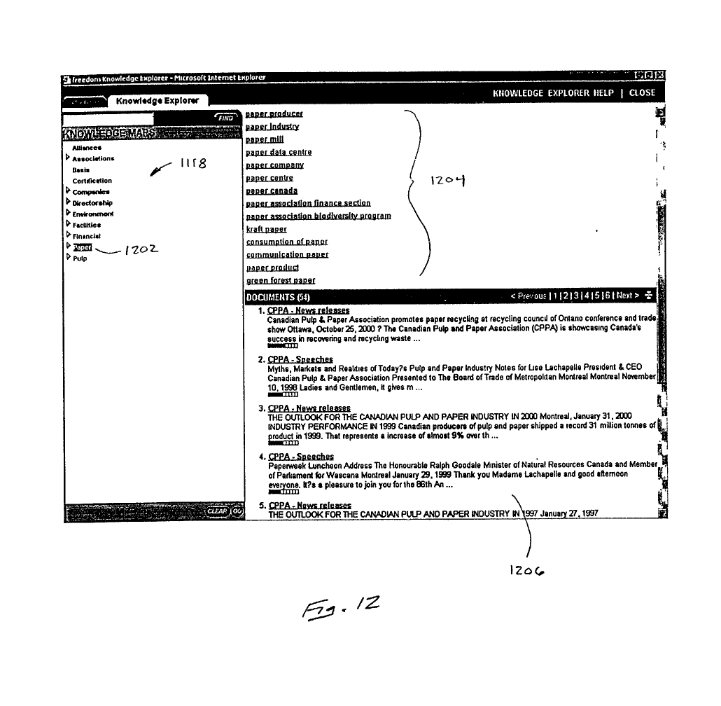

FIG. 13 shows an example knowledge explorer multi-node search result; and

FIG. 14 shows another example knowledge explorer multi-node search result.

### DETAILED DESCRIPTION OF EXEMPLARY EMBODIMENTS

Systems and methods in accordance with the present invention overcome the prior art by providing a corporate portal which, by incorporating pivot portal and knowledge explorer concepts, is configured to provide the user with relevant information gathered and filtered from disparate sources.

Overview

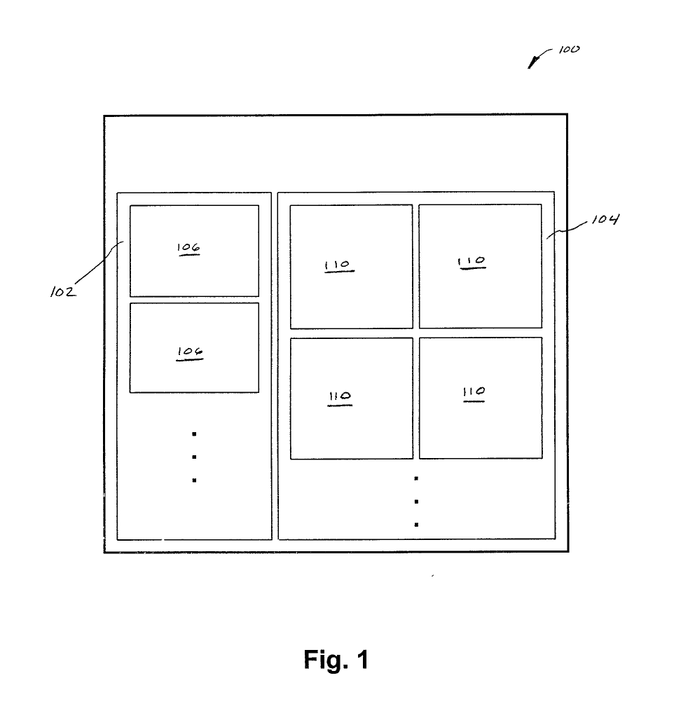

In general, referring now to FIG. 1, a portal page 100 in accordance with one embodiment of the present invention includes at least two panes: a first pane (or “advanced pane”) 102 and a second pane 104. Pane 102 includes at least one knowledge map 106 comprising a plurality of nodes (not shown in FIG. 1), which are selectable by the user. Pane 104, the second pane, includes at least one portal object 110 responsive to the selection of nodes within knowledge maps 106. As described further below, portal objects 110 include information associated with the node selection.

As a preliminary matter, the terms “portal page” and “web page” as used herein are not meant to limit the type of documents and applications that might be used to interact with the user. While a portal generally consists of one or more pages on a website that act as a starting point for browsing, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like. Moreover, the various panes displayed on the portal page may or may not be implemented using standard HTML frames (as illustrated), depending upon anticipated browser compatibility.

As the present invention may be deployed in the context of a large user-base, users preferably communicate with the corporate portal over a large network such as the Internet. As used herein, the term “Internet” refers to the global, packet-switched network utilizing the TCP/IP suite of protocols. Nevertheless, the present invention may be implemented in other network contexts, including intranets, extranets, and any future alternatives to the Internet or “internetworks” based on other open or proprietary protocols. The present system may be implemented using a variety of architectures known in the art. Similarly, various platforms, such as Microsoft's “.Net” platform, may be used for implementation.

Users may access the various servers used to implement the corporate portal using any combination of hardware and software components and any convenient means of data communication. For example, users may utilize a conventional personal computer configured with a suitable operating system and web-browser or, alternatively, a personal data assistant (PDA) configured with a wireless-application protocol (WAP) browser. Those skilled in the art will appreciate that the present invention is not limited to the use of standard web browsers in conjunction with the HTTP protocol, and that a wide range of communication protocols, client software programs, wired and wireless data communication modes, and the like may be employed. User systems might also reside within a local area network (LAN) which interfaces to network 106 via a leased line (T1, D3, etc.). Such communication methods are well known in the art, and are covered in a variety of standard texts. See, e.g., GLBERT HELD, UNDERSTANDING DATA COMMuNICATIONS (1996). Specific information related to the protocols, standards, and application software utilized by in connection with the Internet are known in the art and will not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LosHN, TCP/IP CLEARLY EXPLAINED (1997).

As mentioned briefly in the Background section, a typical prior art corporate portal includes a large number of pages defining the set of business functions that the enterprise and its users wish to accomplish. The user must then navigate through several different pages which have been pre-categorized into business functions, e.g., searching, content management, applications, documents, discussions, and the like.

In accordance with one aspect of the pivot portal, a single page and a single navigation metaphor allows the user to access most business functions for a particular task via a single portal page. This gives the user the ability to filter the content of the portal page to deliver the exact business content required. As described in further detail below, this metaphor is also used in connection with the knowledge explorer, i.e., by allowing the user to choose multiple nodes in a knowledge map to gather and filter results. In general, a knowledge map represents the key dimensions of information that are relevant to the user. The, the intersection of nodes results in highly filtered information that reflects the business information that the end user is interested in seeing.

Pivot Portal

Having thus given an overview of a pivot portal in accordance with the present invention, a particular example will now be described. While the illustrated embodiment is described in terms of particular “customer” and “product” nodes, it will be appreciated that the invention is not so limited, and that any suitable taxonomy may be used, depending upon the application.

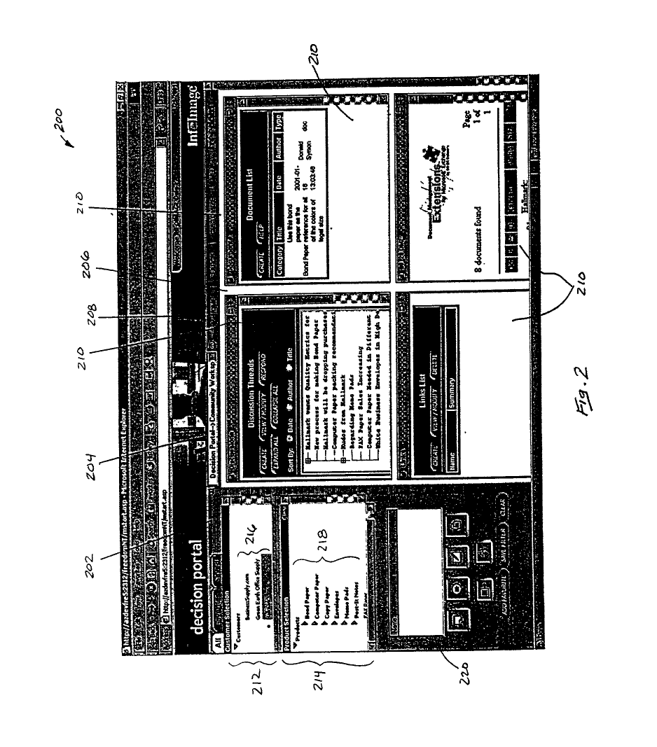

Referring to FIG. 2, an exemplary pivot portal page 200 includes an advanced pane 202, a site menu 204, a second pane 206, and an options menu 208. Pane 206 includes a number of portal objects 210, and advanced pane 202 includes two knowledge maps 212 and 214 having respective sets of nodes 216 and 218 associated therewith. In this embodiment, nodes 216 in knowledge map 212 correspond to particular customers, and nodes 218 in knowledge map 214 correspond to products listed hierarchically in accordance with a product taxonomy.

Site menu 204 controls navigation within the portal. Specifically, in this embodiment, the user chooses the page he wishes to view from a pop-down menu. The Site-Menu will typically be a two-step hierarchy including a main portal category followed by a series of portal pages falling within that category. These categories may be defined during installation and/or by the user for a particular installation.

Advanced pane 202 includes three sub-panes: knowledge map 202 (the customer taxonomy), knowledge map 214 (the product taxonomy), and a collaboration pane 220—an optional sub-pain where other functions pertinent to the page may be shown. In this embodiment, collaboration pane 220 includes a Microsoft NetMeeting interface.

Pane 206 includes two columns of portal objects 210. In this embodiment, the portal objects are distributed in a rectilinear grid of columns in rows. It will be appreciated that many other layouts might also be appropriate.

Portal objects may be implemented in a variety of ways. In one embodiment, portal objects are a combination of XML schemas, ASPs, DLLs, and XSLs that define how the content of the objects are presented. Portal objects may be developed as components using standard Internet technologies, including, for example, DHTML, XML, XSL, JavaScript, and/or VBScript.

Options Menu 206 suitably includes a variety of features accessible by the user. In this embodiment, the default options include: (1) Home—Returns the user to the initial portal page; (2) Search—Takes the user to the Keyword/Knowledge Map help; (3) Customize—Allows the user to create, modify and delete PO on pages, or pages themselves; and (4) Help—Invokes the Help menu for the page. A variety of other options may also be included as may be desired.

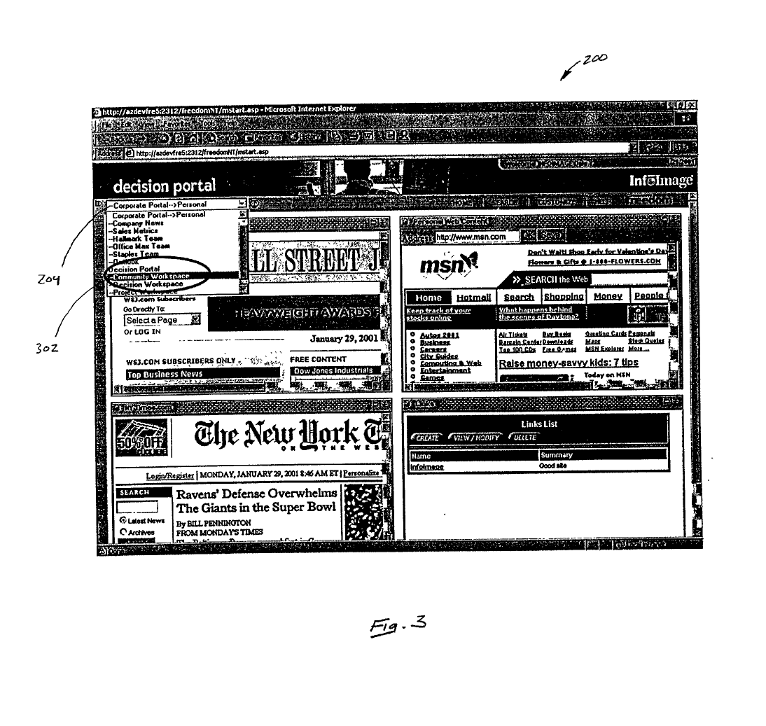

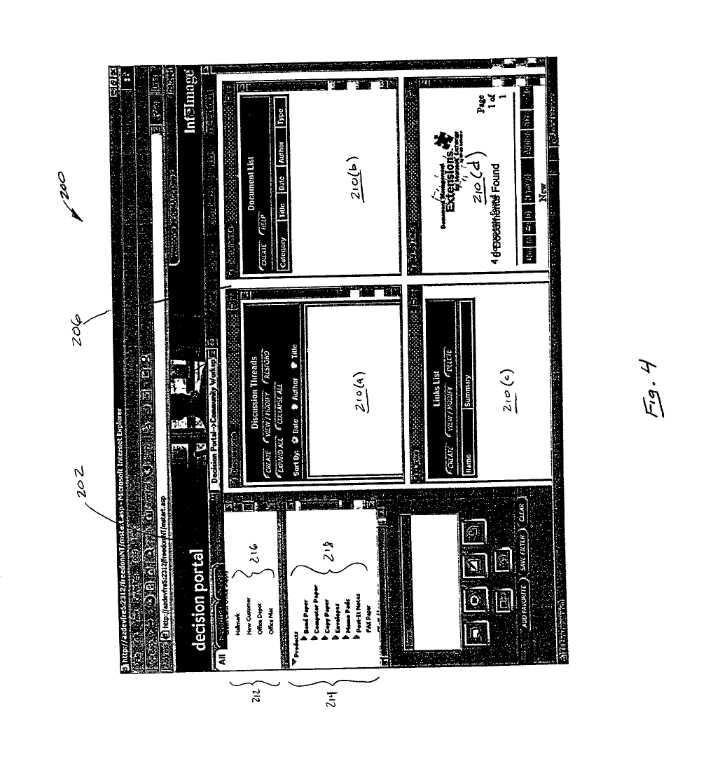

As shown in FIG. 3, using site menu 204 the user may select the “Decision Portal” category and the “Community Workspace” page (302). The result is shown in FIG. 4. At this point, because no “company” or “products” have been selected from knowledge maps 212 or 214, the portal objects 210 (210(a)-(b)) default to showing all of their content, e.g., all orders, or no content, e.g., no experts, depending on the nature default for the type of information being displayed in the respective portal object.

In this embodiment, when the decision portal category 302 is selected, the advanced pane 202 automatically opens up to provide a means for selecting options and navigating to other features in the decision portal.

With continued reference to FIG. 4, advanced pane 202 includes knowledge map 212, which lists customer nodes 216 (taxonomy of customers for the company), and knowledge map 214, which lists product nodes 218 (a collapsible, hierarchical taxonomy of products).

Structurally, the first column of pane 206 includes two portal objects: portal object 210(a), which is dedicated to discussion threads, and portal object 210(c), which is dedicated to a list of links. The second column of pane 206 also includes two portal objects: portal object 210(b), which includes a document list, and portal object 210(d), which is dedicated to another class of documents (e.g., “80-20” documents). As no companies or products have been selected in knowledge maps 212 and 214, no items are shown in portal objects 210.

When the user selects one or more customers in knowledge map 212 and/or one or more products in knowledge map 214, information is gathered (from an appropriate internal or external data source), filtered, then displayed within portal objects 210, thereby reflecting the specific information desired by the user.

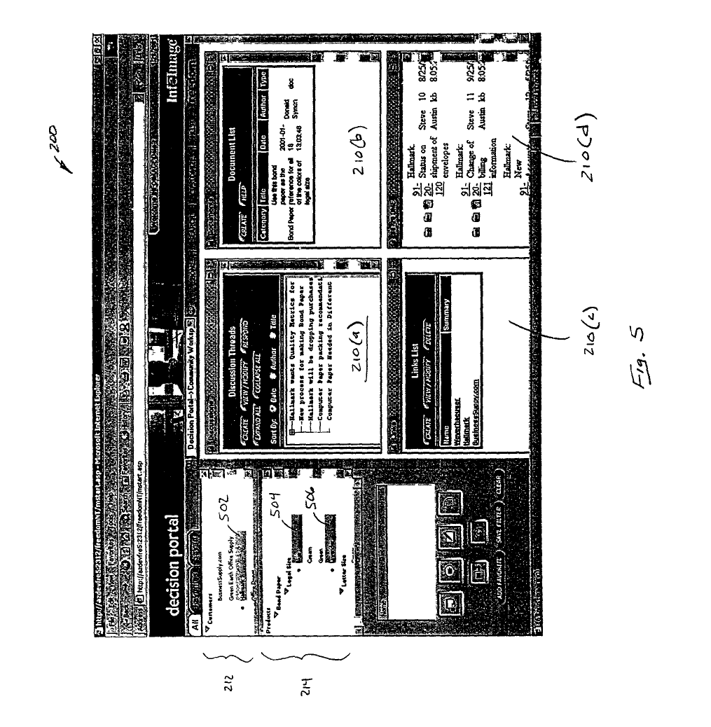

Referring now to FIG. 5, for example, the “Hallmark” item 502 has been selected in knowledge map 212, and the “Blue” and “Lavender” items 504 and 506 have been selected in knowledge map 214 (as indicated by highlighting). As a result, only the data for “Hallmark and Bond Paper, Legal Size, Blue and Lavender” is displayed in portal objects 210. Specifically, portal object 210(a) includes discussions (e.g., newsgroup, e-mail, etc.) related to that customer and those products, portal object 210(b) includes a relevant document list, portal object 210(c) includes links to the Hallmark website and other possibly relevant sites, and portal object 210(d) includes 80-20 documents that are potentially important.

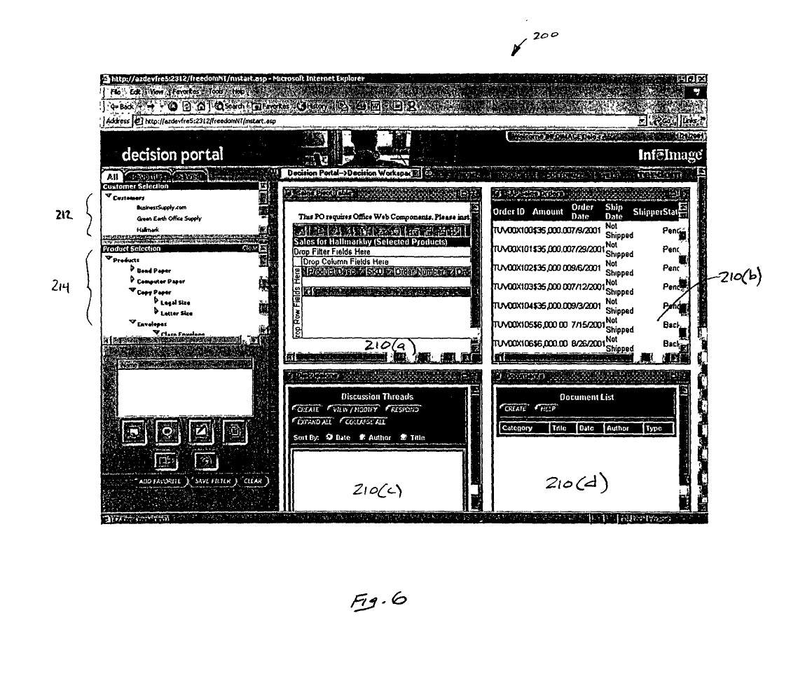

FIG. 6 shows another sample workspace. This workspace emphasizes portal objects that are important in the typical decision making process of a business. Where as the product and customer taxonomies in knowledge maps 212 and 214 are identical to those shown in FIG. 5 (the “community workspace”), the portal objects themselves differ, and are much more focused toward hard business data. More particularly, portal object 210(a) corresponds to sales, portal object 210(b) corresponds to orders, portal object 210(c) corresponds to discussions, and portal object 210(d) corresponds to relevant documents. Note that, as no customers or products have been selected from knowledge maps 212 and 214, portal objects 210 are not populated with content.

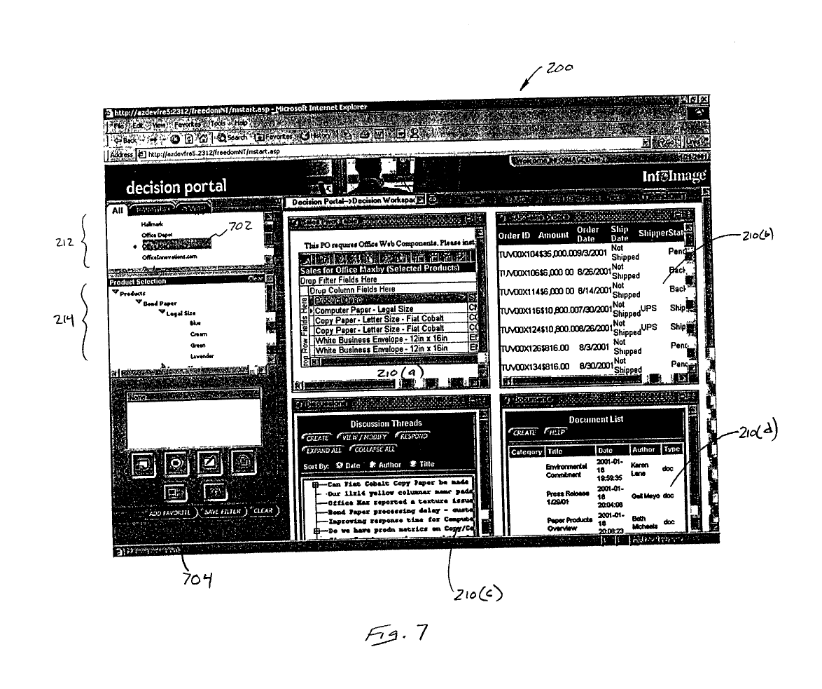

FIG. 7 shows the result after a particular customer 702 has been selected within knowledge map 212 (i.e., Office Max). When the user makes this selection, all pertinent information related to sales, orders, discussion, and documents is gathered and displayed within respective portal objects 210. The user may then scroll through the gathered information, modify the size of the portal objects, etc. The information may be further filtered and analyzed by choosing particular products within knowledge map 214.

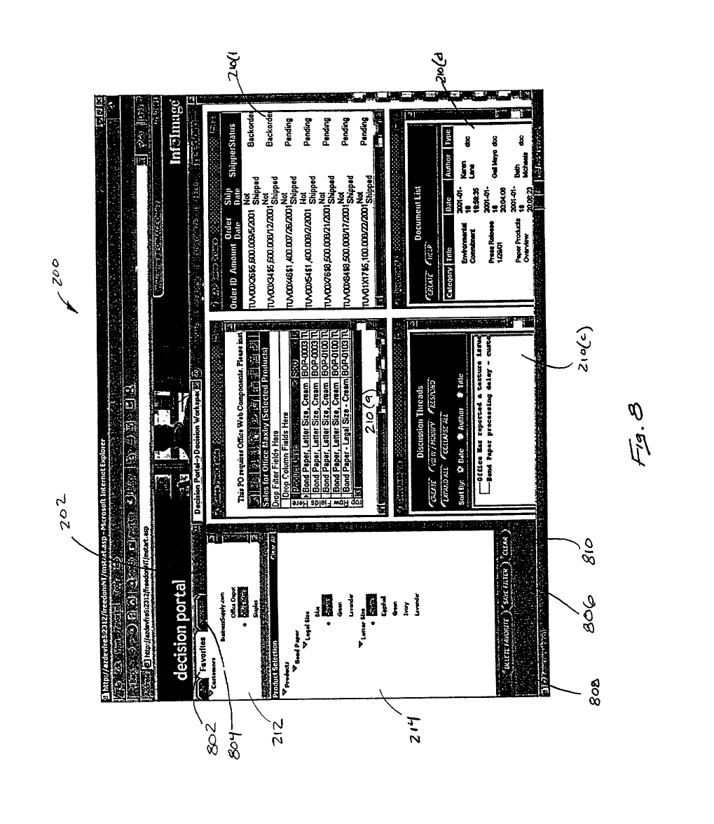

Referring now to FIG. 8, the user experience may be further enhanced by use of the “Favorites” tab 802 and “Saved” tab 804 in advanced pane 202. Since in many companies the number of customers and, potentially, the number of products is fairly large, the present invention provides a way for a user to choose those customers and those products that they wish to focus on. This is the function of “Favorites” tab 802. The user selects those companies and products (within knowledge maps 212 and 214) that are most important, then clicks on the “Add Favorite” button (item 704 in FIG. 7). By then selecting the Favorites tab 802, the user is given knowledge maps that contain only those items that have been selected. The user may then choose one or more customers and one or more products, whereupon the results are displayed in the respective portal objects 210.

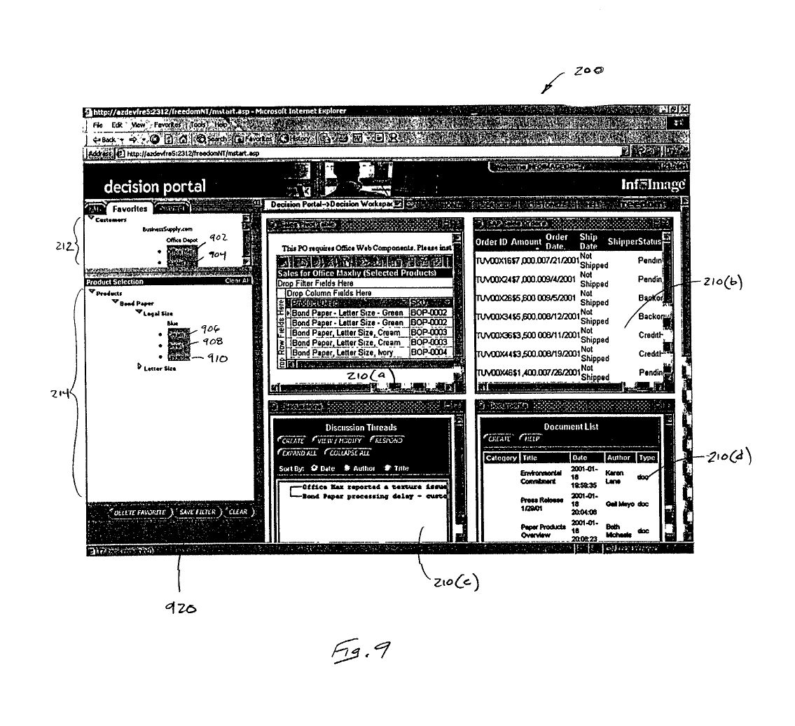

Another advanced feature that the present invention provides is the logical “joining” of two or more nodes from within the same or multiple knowledge maps. Referring to FIG. 9, for example, when the user selects Office Max 902 and Stapes 904, and products 906-908, the Pivot Portal “ands” the results and displays results for both companies and products in each portal object 210. This type of decision-making information is almost impossible to achieve in a conventional corporate portal, as the portal objects or pages would need to be designed and implemented around each specific query the user wished to make.

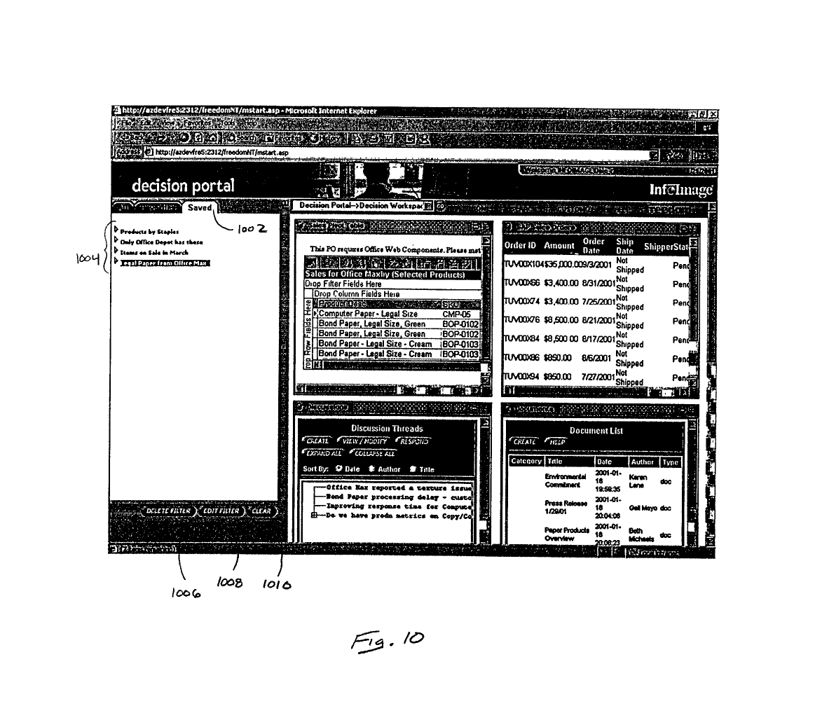

In the process of reviewing information, users often locate particular information that they would like to see updated frequently. This “subscription” functionality is implemented in the present invention by the use of the Save Filter function (920). By making a selection of one or more companies and one or more products and then clicking on Save Filter button 920, the user is saving the result of a particular selection of nodes. By doing this, the user is effectively subscribing to this content, and thus the query is saved so that each time the information corresponding to the node selection is required, the user can access it by clicking on the Saved tab 1002 and then choosing the desired Saved Filter as shown in FIG. 10. In the illustrated example, a number of saved queries 1004 are listed, and the query result for “Legal Paper from OfficeMax” is selected. Note also that this embodiment includes an Edit Filter button 1008 (which allows editing of the query or filter), and a Clear button 1010, which clears the current selection.

Knowledge Explorer

Not all information required in a business process is available in a predictable format or is readily available. That is, in addition to process-oriented information, many business decisions require the analysis of ad hoc information. Historically, this type of information is not easily found, and traditional tools such as keyword searches and the like are often unproductive and frustrating to the user. To overcome this limitation, one embodiment of the present invention incorporates a knowledge explorer which allows the user to select multiple nodes to harness the power of intersecting knowledge maps.

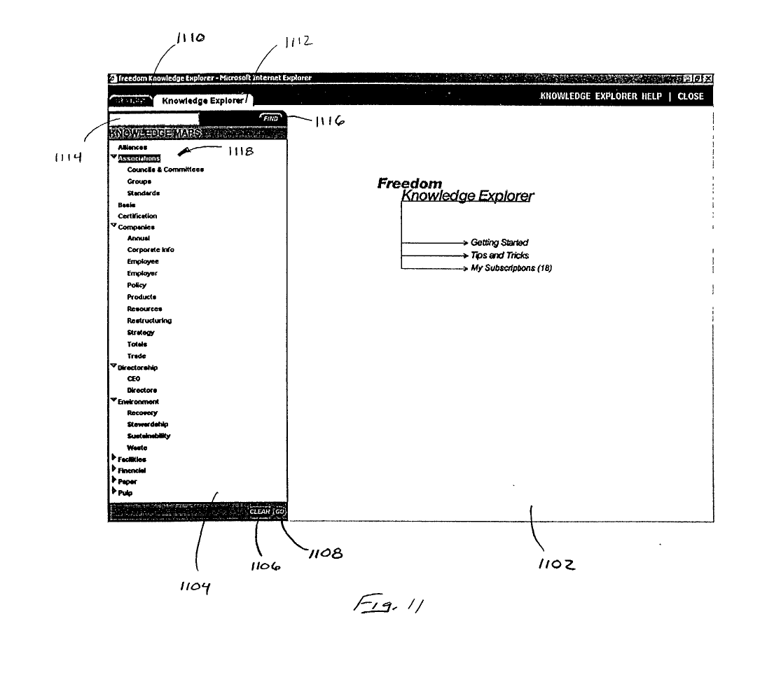

FIG. 11 shows an exemplary knowledge explorer interface 1110. A knowledge explorer tab 1112 includes a search field 1114 and corresponding Find button 116. A list of knowledge maps 1104 are listed, and the user may select one or more of these knowledge maps (map 1118 is selected in the example). A Clear button 1106 is provided for clearing the current selection, and a Go button is provided 1108 for engaging the knowledge explorer process.

As with the pivot portal described above, the user can quickly filter search results by using the knowledge explorer. For example, FIG. 11 shows the results of searching for “paper” by selecting node 1202 in the knowledge map 1118. As shown, the results are very different from a standard keyword search in that the search returned not only a set of documents 1206, but also a set of concepts 1204. These concepts 1204 are areas which may assist the user in further filtering of results. This information is the result of the products use of a relevance cube, which relates different types of information together in ways that may not be apparent to the end user.

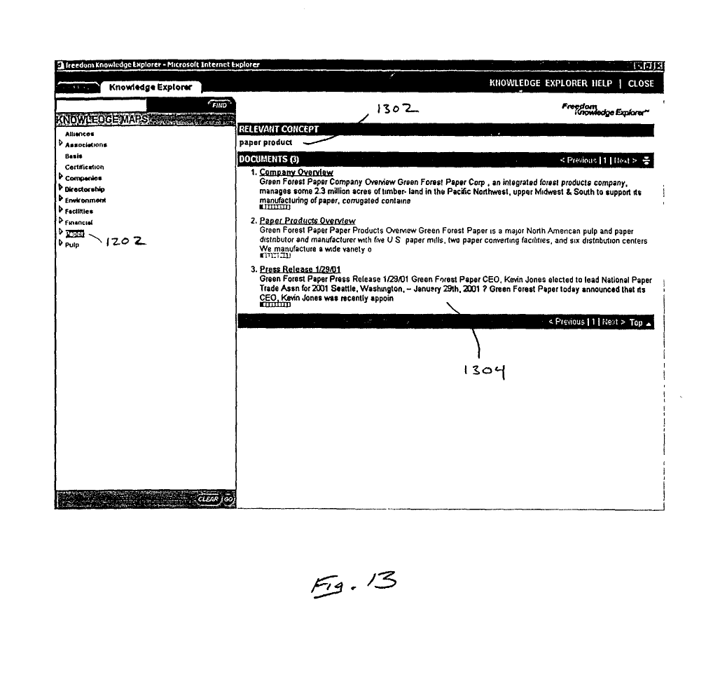

At this point the user might choose additional nodes in the knowledge map 1118, or may select a relevant concept 1204 that in fact may be closer to the original task the user was trying to accomplish. For example, consider the case where the user selects “Paper Products” from the Relevant Concepts area 1204. As shown in FIG. 13, this yields a result with only three documents 1304 with only relevant concept 1302 isolated.

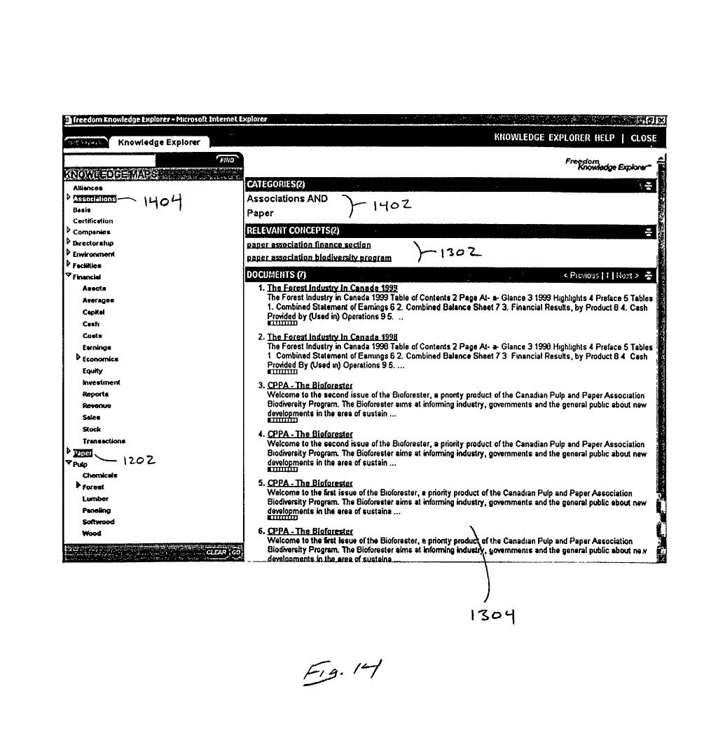

Another alternative includes further refining the search by choosing additional nodes from the Knowledge Map. As shown in FIG. 14, “Associations” and “Paper” were selected. The result is seven documents 1304, plus two additional Relevant Concepts 1302.

It will be appreciated that systems and methods have been presented which greatly simplify the concept of portals and the navigation of available information. Instead of requiring three to five different portal pages to execute a decision process, it can all be done in one or two pages.

Although the invention has been described herein in conjunction with the appended drawings, those skilled in the art will appreciate that the scope of the invention is not so limited. Various modifications in the selection, design, and arrangement of the various components and steps discussed herein may be made without departing from the scope of the invention as set forth in the appended claims.

What is claimed is:

1. A portal accessible by a plurality of users over a network, said portal comprising:
a portal page including a first pane and a second pane;
said first pane including at least one knowledge map, said knowledge map comprising a plurality of nodes selectable by said user;
said second pane including at least one portal object responsive to said selection of said nodes within said at least one knowledge map, said portal object comprising information associated with said selection of said nodes.

2. The portal of claim 1, wherein said nodes in said knowledge map are displayed to said user in accordance with a taxonomy.

3. The portal of claim 1, further including a knowledge explorer configured to allow said user to select multiple nodes.

4. The portal of claim 1, wherein said information associated with said selection of said nodes comprises data gathered from at least one data source and filtered in accordance with said selection of said nodes.

5. The portal of claim 1, further including a site menu configured to allow said user to select said portal page from a plurality of pages arranged in a hierarchy.

6. The portal of claim 1, further including a list of favorites associated with said user, said list of favorites including one or more of said nodes.

7. The portal of claim 1, wherein said portal page comprises HTML served to said user in accordance with the HTTP protocol.

8. The portal of claim 1, wherein said portal objects are displayed in a rectilinear pattern of columns and rows.

9. A method for providing portal access to a plurality of users over a network, said method comprising the steps of:
transmitting a portal page to said user in response to a request from said user, wherein said portal page includes a first pane and a second pane;
said first pane including at least one knowledge map, said knowledge map comprising a plurality of nodes selectable by said user;
said second pane including at least one portal object responsive to said selection of said nodes within said at least one knowledge map, said portal object comprising information associated with said selection of said nodes.

10. The method of claim 9, further including the step of displaying said nodes in said knowledge map in accordance with a taxonomy.

11. The method of claim 9, further including the step of providing a knowledge explorer configured to allow said user to select multiple nodes.

12. The method of claim 9, further including the step gathering data from at least one data source and filtering said gathered data in accordance with said selection of said nodes.

13. The method of claim 9, further including the step of providing a site menu configured to allow said user to select said portal page from a plurality of pages arranged in a hierarchy.

14. The method of claim 9, further including the step of providing a list of favorites associated with said user, said list of favorites including one or more of said nodes.
